(19) United States
(12) Patent Application Publication
(10) Pub. No.: US 2010/0228382 A1
(43) Pub. Date: Sep. 9, 2010

(54) IN-LINE WAFER MEASUREMENT DATA COMPENSATION METHOD

(75) Inventor: CHUNG-PEI CHAO, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., Taoyuan County (TW)

(21) Appl. No.: 12/476,548

(22) Filed: Jun. 2, 2009

(30) Foreign Application Priority Data
Mar. 6, 2009 (TW) 98107292

(51) Int. Cl. G06F 19/00

(52) U.S. Cl. 700/121

(57) ABSTRACT

An in-line wafer measurement data compensation method is presented, and the steps of the method includes: acquire a pre-wafer measurement data, a current wafer measurement data, and a current offset; establish an auto regressive integrated moving average (ARIMA) model and an exponential weighted integrated moving average (EWIMA) model, and input the pre-wafer measurement data, the current wafer measurement data, and the current offset to the ARIMA model and the EWIMA model; then get outputs of the ARIMA model and EWIMA model, wherein the outputs are wafer estimation data. Thereby, the semiconductor manufacturer could reduce the sampling time of an in-line measurement and still maintain an acceptable production performance and maintain control process stability.

### BACKGROUND OF THE INVENTION

1. Field of the Invention

The present invention relates to an in-line measurement data compensation method, especially for an in-line wafer measurement data compensation method.

2. Description of Related Art

During processes of manufacturing a wafer, it is important to measure in-line wafer data and control the stability of the processes. To be more specific, a wafer is made into a functional product via a plurality of processing steps, and before proceeding every process for a group of wafers, a former wafer measurement data of the group of wafer must first be acquired, so that the wafer measurement data may feedback to a controller, and thereby the controller may fine-tune parameters of one of the processes that is currently proceeding in accordance to the former wafer measurement data of the former group of wafer.

Because the number of wafers on a production line is numerous, so that if every wafer were to be measured, meaning that a method of sampling wafer measurement data is not be used, then the time require on the production line becomes too long. On the other hand, if a method of sampling wafer measurement data is used, some important wafer measurement data maybe be missed due to the nature of sampling. When those wafers which are not measured later proceeds to a next process, the controller does not fine-tune parameters of the next process due to the lack of former wafer measurement data, therefore the yields of these wafers may be negatively affected.

Hence, the inventors of the present invention believe that the shortcomings described above are able to be improved and finally suggest the present invention which is of a reasonable design and is an effective improvement based on deep research and thought.

### SUMMARY OF THE INVENTION

It is an object of the present invention to provide an in-line wafer measurement data compensation method. Thereby, the frequency of sampling in-line measurement data can be reduced so that the production time can be reduced, yet the yield of wafers and the stability of wafer production process can be maintained.

To achieve the above object, the steps of the in-line wafer measurement data compensation method includes: establish an auto regressive moving average model and an exponential weighted moving average model. Get first to Nth sets of measurement data and the Nth set of offset estimation. Determine whether or not the Nth set of measurement data has outliers and input the first to Nth sets of measurement data to the auto regressive moving average model. Input the Nth set of measurement data and the Nth set of offset estimation to the exponential weighted moving average model. Finally get the outputs of the auto regressive moving average model and the exponential weighted moving average model.

The present invention further provides another in-line wafer measurement data compensation method, and the steps of the method include: establish an auto regressive moving average model and an exponential weighted moving average model. Get first to Nth sets of measurement data and the Nth offset estimation. Determine whether or not the Nth measurement data has outliers and count whether or not the number of outliers exceeds an upper limit. If the number of outliers exceeds the upper limit, the Nth measurement data is directly deleted. If the number of outliers did not exceed the upper limit, input those data within the Nth measurement data which are not classified to outliers and input the first to N−1th measurement data to the auto regressive moving average model. And then input those data within the Nth measurement data which are not classified to outliers and input the Nth offset estimation to the exponential weighted moving average model. Finally get the outputs of the auto regressive moving average model and the exponential weighted moving average model.

The advantages of the present invention are described below: a user can get estimation of wafer measurement data from the auto regressive moving average model and the exponential weighted moving average model, and then use the estimation of measurement data to compensation for the lacked measurement data resulting from the nature of sampling. Thereby, the frequency of sampling in-line measurement data can be reduced so that the production time can be reduced, and the yield of wafers and the stability of wafers production process can be maintained and is not decreased.

### BRIEF DESCRIPTION OF THE DRAWINGS

FIG. 1 is a flowchart according to the first embodiment of the present invention.

FIG. 2 is a comparison between a long term measurement data and estimation data.

FIG. 3 is a comparison between a short term measurement data and estimation data.

FIG. 4 is a flowchart according to the second embodiment of the present invention.

### DETAILED DESCRIPTION OF THE PREFERRED EMBODIMENTS

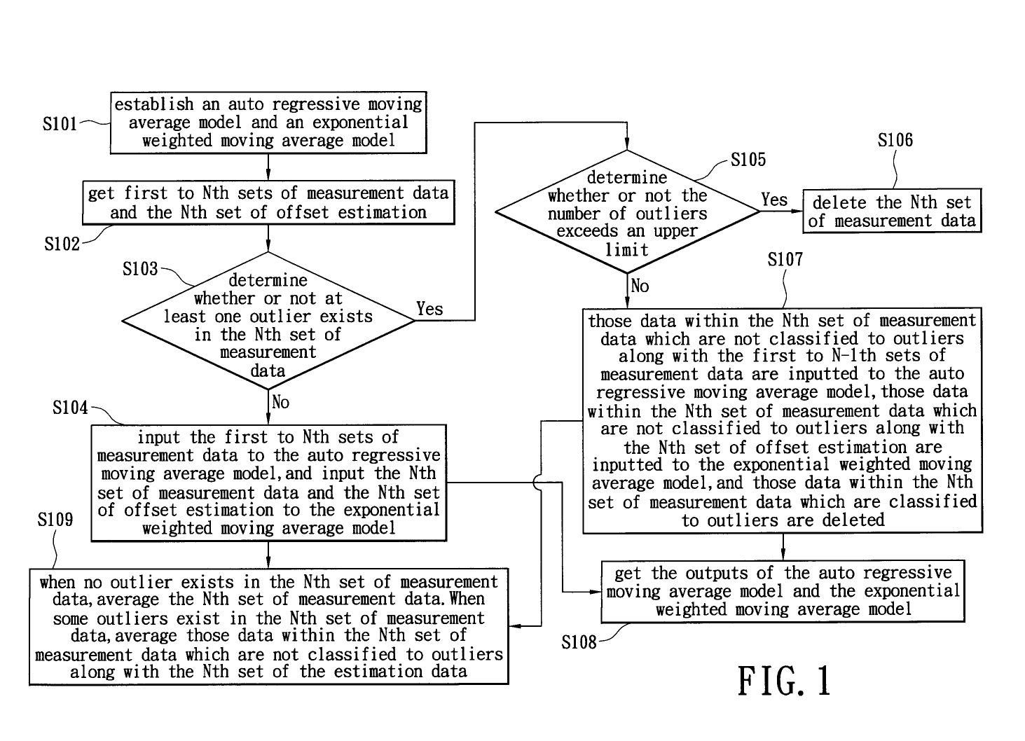

Refer to FIG. 1, the present invention provides an in-line wafer measurement data compensation method, and the method includes step S101 to Step S108.

In step S101, establish an auto regressive moving average model and an exponential weighted moving average model.

In step S102, get first to Nth sets of measurement data and the Nth set of offset estimation, wherein the sets of measurement data represent wafer's specification, such as film's thickness, etching state and so forth, the offset estimation represents difference between the measurement data and the estimation data.

In step S103, determine whether or not at least one outlier exists in the Nth set of measurement data, if no outlier exists in the Nth set of measurement data, then proceed to step S104 and subsequently to step S109; if some outlier exist in the Nth set of measurement data, then proceed to step S105.

In step S104, input the first to Nth sets of measurement data to the auto regressive moving average model, input the Nth set of measurement data and the Nth set of offset estimation to the exponential weighted moving average model.

In step S105, determine whether or not the number of outliers exceeds an upper limit, if the determination is yes, then proceed to step S106; if the determination is no, then proceed to step S107 and then subsequently to step S108.

In step S106, delete the Nth set of measurement data.

In step S107, those data within the Nth set of measurement data which are not classified to outliers along with the first to N−1th sets of measurement data are inputted to the auto regressive moving average model; those data within the Nth set of measurement data which are not classified to outliers along with the Nth set of offset estimation are inputted to the exponential weighted moving average model; as for those data within the Nth set of measurement data which are classified to outliers are deleted.

In step S108, get the outputs of the auto regressive moving average model and the exponential weighted moving average model, wherein the output of the auto regressive moving average model represents N+1 set of long term estimation data.

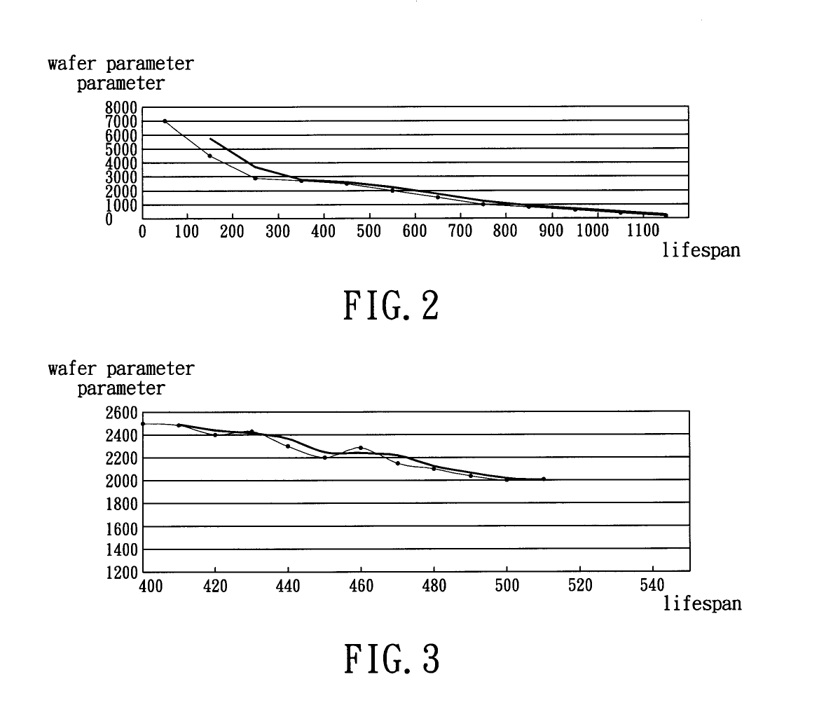

As shown in FIG. 2, wherein the thinner line represents a set of long term wafer data estimated by the auto regressive moving average model, the thicker line represents a set of long term real wafer measurement data, the transverse axis represents a machine lifespan, and the vertical axis represents a wafer's specification. The output of the exponential weighted moving average model represents the N+1th set of offset estimation, as shown in FIG. 3, wherein the transverse axis represents a machine life span, the vertical axis represents a wafer's specification, the thinner line represents a set of short term wafer data estimated by the auto regressive moving average model, the thicker line represents a set of short term real wafer measurement data, and a difference between the thinner line and the thicker line represents offset estimation.

On a production line, some sets of wafers are not actually measured due to the nature of sampling, and those sets that lack measurement data are compensated by the outputs of the auto regressive moving average model and the exponential weighted moving average model.

On the other hand, when no outlier exists in the Nth set of measurement data, average the Nth set of measurement data in step S109. When some outliers exist in the Nth set of measurement data, average those data within the Nth set of measurement data which are not classified to outliers in step S109.

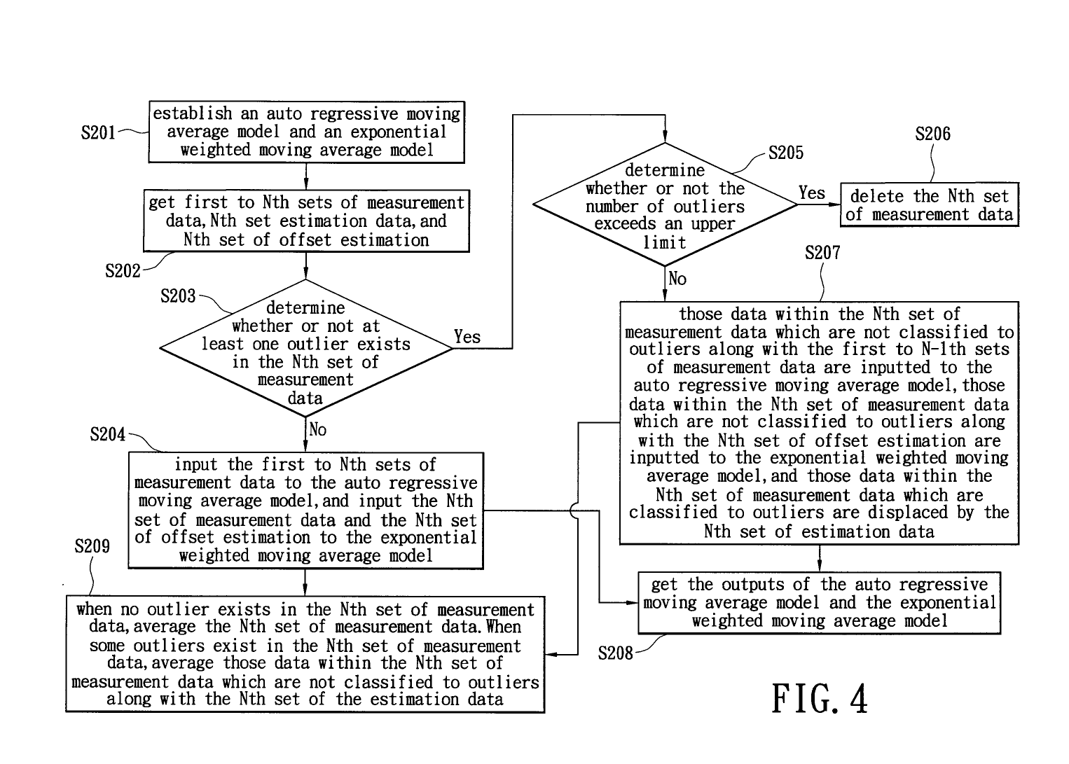

As shown in FIG. 4, the present invention provides another in-line wafer measurement data compensation method, and the method includes step S201 to step S208.

In step S201, establish an auto regressive moving average model and an exponential weighted moving average model.

In step S202, get first to Nth sets of measurement data, the Nth set estimation data, and the Nth set of offset estimation, wherein the sets of measurement data represent wafer's specification, such as film's thickness, etching state and so forth, the offset estimation represents difference between the measurement data and the estimation data.

In step S203, determine whether or not at least one outlier exists in the Nth set of measurement data, if no outlier exists in the Nth set of measurement data, then proceed to step S204 and subsequently to step S209; if some outlier exist in the Nth set of measurement data, then proceed to step S205.

In step S204, input the first to Nth sets of measurement data to the auto regressive moving average model, input the Nth set of measurement data and the Nth set of offset estimation to the exponential weighted moving average model.

In step S205, determine whether or not the number of outliers exceeds an upper limit, if the determination is yes, then proceed to step S206; if the determination is no, then proceed to step S207 and subsequently to step S208.

In step S206, delete the Nth set of measurement data.

In step S207, those data within the Nth set of measurement data which are not classified to outliers along with the first to N−1th sets of measurement data are inputted to the auto regressive moving average model; those data within the Nth set of measurement data which are not classified to outliers along with the Nth set of offset estimation are inputted to the exponential weighted moving average model; those data within the Nth set of measurement data which are classified to outliers are displaced by the Nth set of estimation data.

In step S208, get the outputs of the auto regressive moving average model and the exponential weighted moving average model, wherein the output of the auto regressive moving average model represents the N+1th set of long term estimation data, and the output of the exponential weighted moving average model represents the N+1th set of offset estimation. Some sets of wafers are not actually measured due to the nature of sampling, and those sets that lack measurement data are compensated by the outputs of the auto regressive moving average model and the exponential weighted moving average model.

On the other hand, when no outlier exists in the Nth set of measurement data, average the Nth set of measurement data in step S209. When some outliers exist in the Nth set of measurement data, average those data within the Nth set of measurement data which are not classified to outliers along with the Nth set of the estimation data in step S209.

The advantages of the in-line wafer measurement data compensation method are described as follows: a user can get estimation of wafer measurement data from the auto regressive moving average model and the exponential weighted moving average model, and use the estimated measurement data to compensation for the lacked measurement data that resulted from the nature of sampling. Thereby, the frequency of sampling in-line measurement data can be reduced so that the production time can be reduced, and the yield of wafers and the stability of wafers production process can be maintained and not decreased.

What are disclosed above are only the specification and the drawings of the preferred embodiment of the present invention and it is therefore not intended that the present invention be limited to the particular embodiment disclosed. It is to be understood by those skilled in the art that various equivalent changes may be made depending on the specification and the drawings of the present invention without departing from the scope of the present invention.

What is claimed is:

1. An in-line wafer measurement data compensation method, comprising:
establish an auto regressive moving average model and an exponential weighted moving average model;
get first to Nth sets of measurement data and the Nth set of offset estimation;
determine whether or not at least one outlier exists in the Nth set of measurement data;
input the first to Nth sets of measurement data to the auto regressive moving average model;
input the Nth set of measurement data and the Nth set of offset estimation to the exponential weighted moving average model; and
get the outputs of the auto regressive moving average model and the exponential weighted moving average model, wherein the output of the auto regressive moving average model represents estimation data, and the output of the exponential weighted moving average model represents offset estimation.

2. The in-line wafer measurement data compensation method as claimed in claim 1, wherein the sets of measurement data represent wafer's specification.

3. The in-line wafer measurement data compensation method as claimed in claim 1, wherein the offset estimation represents a difference between the measurement data and the estimation data.

4. The in-line wafer measurement data compensation method as claimed in claim 1, further comprising a step of averaging the Nth set of measurement data.

5. The in-line wafer measurement data compensation method as claimed in claim 1, further comprising a step of averaging those data within the Nth set of measurement data which are not classified to outliers.

6. The in-line wafer measurement data compensation method as claimed in claim 1, wherein the output of the auto regressive moving average model represents first to N+1th set of long term estimation data, and the output of the exponential weighted moving average model represents first to N+1th set of offset estimation.

7. An in-line wafer measurement data compensation method, comprising:
establish an auto regressive moving average model and an exponential weighted moving average model;
get first to Nth sets of measurement data and the Nth set of offset estimation;
determine whether or not at least one outlier exists in the Nth set of measurement data;
determine whether or not the number of outliers exceeds a upper limit, if the determination is yes, then directly delete the Nth set of measurement data; if the determination is no, then proceed to the following steps;
input those data within the Nth set of measurement data which are not classified to outliers and input the first to N−1th sets of measurement data to the auto regressive moving average model;
input those data within the Nth set of measurement data which are not classified to outliers and input the Nth set of offset estimation to the exponential weighted moving average model; and
get the outputs of the auto regressive moving average model and the exponential weighted moving average model.

8. The in-line wafer measurement data compensation method as claimed in claim 7, wherein the sets of measurement data represent wafer's specification.

9. The in-line wafer measurement data compensation method as claimed in claim 7, wherein the offset estimation represents a difference between the measurement data and the estimation data.

10. The in-line wafer measurement data compensation method as claimed in claim 7, further comprising a step of averaging the Nth set of measurement data.

11. The in-line wafer measurement data compensation method as claimed in claim 7, further comprising a step of averaging those data within the Nth set of measurement data which are not classified to outliers along with the Nth set of estimation data.

12. The in-line wafer measurement data compensation method as claimed in claim 7, wherein the output of the auto regressive moving average model represents first to N+1th set of long term estimation data, and the output of the exponential weighted moving average model represents first to N+1th set of offset estimation.

13. The in-line wafer measurement data compensation method as claimed in claim 7, further comprising a step of deleting those data within the Nth set of measurement data which are classified to outliers.

14. The in-line wafer measurement data compensation method as claimed in claim 7, further comprising a step of displacing those data within the Nth set of measurement data which are classified to outliers by the Nth set of estimation data.
